(19) United States
(12) Patent Application Publication
(10) Pub. No.: US 2023/0140696 A1
(43) Pub. Date: May 4, 2023

(54) METHOD AND SYSTEM FOR OPTIMIZING PARAMETER INTERVALS OF MANUFACTURING PROCESSES BASED ON PREDICTION INTERVALS

(71) Applicant: ELECTRONICS AND TELECOMMUNICATIONS RESEARCH INSTITUTE, Daejeon (KR)

(72) Inventors: Jung Won YU, Daejeon (KR); Jin Hong KIM, Daejeon (KR); Young Jae LEE, Daejeon (KR); Kil Taek LIM, Daejeon (KR)

(21) Appl. No.: 17/902,048

(22) Filed: Sep. 2, 2022

(30) Foreign Application Priority Data
Nov. 3, 2021 (KR) 10-2021-0149915

(51) Int. Cl. G05B 13/04; G05B 13/02

(52) U.S. Cl. CPC G05B 13/042; G05B 13/048; G05B 13/0265

(57) ABSTRACT

Provided is a method of optimizing parameter intervals of manufacturing processes based on prediction intervals. The method includes: collecting process data by applying an experiment design method to a target process; training a second-order polynomial regression model based on the collected process data; estimating importance values of each input variable with respect to each output variable using the second-order polynomial regression model; defining an objective function for process optimization based on the second-order polynomial regression model; optimizing each parameter value by applying an optimization algorithm to the defined objective function; and optimizing each parameter interval including the optimized parameter value in an input space using the prediction interval of the second-order polynomial regression model.

### CROSS-REFERENCE TO RELATED APPLICATION

This application claims priority to and the benefit of Korean Patent Application No. 10-2021-0149915, filed on Nov. 3, 2021, the disclosure of which is incorporated herein by reference in its entirety.

### BACKGROUND

### 1. Field of the Invention

The present invention relates to a method and system for optimizing parameter intervals for manufacturing processes based on prediction intervals, and more particularly, to a method and system for recommending, to a user, optimal intervals of each process parameter considering uncertainty of manufacturing processes using prediction intervals of a second-order polynomial regression model.

### 2. Description of Related Art

One of the widely used methods to optimize manufacturing processes is to use a second-order polynomial regression model.

In general, regression analysis is an academic field that sets target variables of interest and explanatory variables (input variable) that affect the target variable (output variable) and then statistically identifies functional relationships between the target variables and the explanatory variables.

The regression analysis methods are divided into a case of one independent variable and a case of two or more independent variables. The case where there is only one independent variable is called simple regression analysis, and the case where there are two or more independent variables is called multiple regression analysis.

In the case of performing process optimizations based on the second-order polynomial regression model, process uncertainty is caused due to measurement errors of quality variables, setting errors of process parameters, errors caused by omission of uncontrollable factors (e.g., temperature and humidity). In consideration of such uncertainty, there is a need for a technology for optimizing each parameter interval along with values of each parameter that may obtain desired quality responses and providing a user with the optimized parameter intervals and values.

### SUMMARY OF THE INVENTION

The problem to be solved by the present invention is to provide a method and system for optimizing parameter intervals of manufacturing processes based on prediction intervals capable of optimizing each process parameter interval so that all process parameter vectors included in an input space defined by the optimized parameter intervals may obtain quality values statistically similar to those of optimized parameter vectors.

However, the problems to be solved by the present invention are not limited to the problems described above, and other problems may be present.

According to a first aspect of the present invention, a method of optimizing parameter intervals of manufacturing processes based on prediction intervals includes: collecting process data by applying an experiment design method to a target process; training a second-order polynomial regression model based on the collected process data; estimating importance values of each input variable with respect to each output variable using the second-order polynomial regression model; defining an objective function for process optimization based on the second-order polynomial regression model; optimizing each parameter value by applying an optimization algorithm to the defined objective function; and optimizing each parameter interval including the optimized parameter value in an input space using the prediction interval of the second-order polynomial regression model.

According to a second aspect of the present invention, a system for optimizing parameter intervals of manufacturing processes based on prediction intervals includes: a communication module that receives process data collected by applying a predetermined experimental design method to a target process; a memory in which a program for optimizing the parameter intervals based on the process data is stored; and a processor that executes the program stored in the memory. The processor trains a second-order polynomial regression model based on the collected process data by executing the program, estimates importance values of each input variable for each output variable using the trained second-order polynomial regression model, define an objective function for process optimization based on the trained second-order polynomial regression model, and optimizes each parameter value by applying an optimization algorithm to the defined objective function and then optimizes each parameter interval including the optimized parameter value in an input space using the prediction interval of the second-order polynomial regression model.

A computer program according to another aspect of the present invention for solving the above-described problems is combined with a computer that is hardware to execute the method of optimizing parameter intervals of manufacturing processes based on prediction intervals, and is stored in a computer-readable recording medium.

Other specific details of the invention are contained in the detailed description and drawings.

### BRIEF DESCRIPTION OF THE DRAWINGS

FIG. 1 is a diagram for schematically describing a manufacturing process.

FIG. 2 is a flowchart of a method of optimizing parameter intervals of manufacturing processes based on prediction intervals according to an embodiment of the present invention.

FIG. 3 is a diagram illustrating an example of a defined hyper-rectangle in an embodiment of the present invention.

FIG. 4A and FIG. 4B are a diagram for describing a process of optimizing process parameter intervals.

FIG. 5 is a diagram for describing a system for optimizing parameter intervals of manufacturing processes based on prediction intervals according to an embodiment of the present invention.

### DETAILED DESCRIPTION OF EXEMPLARY EMBODIMENTS

Various advantages and features of the present invention and methods accomplishing them will become apparent from the following description of embodiments with reference to the accompanying drawings. However, the present invention is not limited to embodiments to be described below, but may be implemented in various different forms, these embodiments will be provided only in order to make the present invention complete and allow those skilled in the art to completely recognize the scope of the present invention, and the present invention will be defined by the scope of the claims.

Terms used in the present specification are for explaining embodiments rather than limiting the present invention. Unless otherwise stated, a singular form includes a plural form in the present specification. Throughout this specification, the term “comprise” and/or “comprising” will be understood to imply the inclusion of stated constituents but not the exclusion of any other constituents. Like reference numerals refer to like components throughout the specification and “and/or” includes each of the components described and includes all combinations thereof. Although “first,” “second,” and the like are used to describe various components, it goes without saying that these components are not limited by these terms. These terms are used only to distinguish one component from other components. Therefore, it goes without saying that the first component described below may be the second component within the technical scope of the present invention.

Unless defined otherwise, all terms (including technical and scientific terms) used in the present specification have the same meaning as meanings commonly understood by those skilled in the art to which the present invention pertains. In addition, terms defined in commonly used dictionary are not ideally or excessively interpreted unless explicitly defined otherwise.

The present invention relates to a method and system 100 for optimizing parameter intervals of manufacturing processes based on prediction intervals.

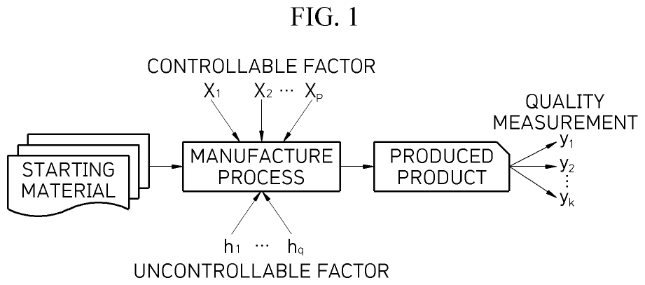

FIG. 1 is a diagram for schematically describing a manufacturing process.

In the manufacturing process, as illustrated in FIG. 1, a starting material is mechanically, physically, and chemically treated, and thus, a geometric structure, properties, appearance, and the like of the starting material are changed to produce a finished product or an intermediate product. The quality of a product is evaluated by measuring several quality variables from the produced product, and the state of the starting material, controllable factors (e.g., rotational speed, pressure, or the like of equipment), and uncontrollable factors (e.g., weather, temperature, and humidity, etc.) affect quality variables.

Improving the quality of the product while reducing the cost and time required to produce a product is the main goal of the manufacturing sector. This can be achieved by optimally selecting values of controllable factors that have a large influence on quality.

In the manufacturing field, it is necessary to appropriately select the values of controllable factors (input parameters) that may obtain optimal quality desired by a user. To do this, first, functional relationships (process models) between the controllable factors (input variables) and quality variables (output variables) should be identified. Regression analysis, a machine learning method, or the like may be used for process modeling to find functional expressions between the controllable factors as the input variables and the quality variables as the output variable.

After identifying the functional relationships between the inputs and outputs, the objective functions defined based on the identified functional relationships, and the optimization algorithm may be applied to the objective function to find the values of the input variables (controllable factors) that make the values of the output variables (quality variables) the user's desired values (maximum, minimum, and desired target values). This is called a process optimization operation, and the values of the input variables obtained in this way are also called an optimal recipe.

On the other hand, in order to learn the process models, an experimental data set composed of observed values of input/output pairs is required. In order to systematically collect the experimental data set from the target process, experimental design methods such as a full factorial design, a central composite method, and a Bax-Benken design are widely used. In this case, the experimental design method evenly arranges points where the experiment is performed in the input space while minimizing the number of times of experiments required to collect data.

The most widely used method to make the process model based on the data collected by this experimental design method is a method of using a second-order polynomial regression model.

The second-order polynomial regression model has the advantage of relatively low model complexity, capturing the nonlinearity contained in target data well, and having high interpretability, and therefore, is widely used for process modeling and optimization in various fields.

After training the process model, the objective function of the process optimization problem may be defined based on the trained process model. To define the objective function in consideration of a trade-off between several quality variables having different ranges, the desirability function approach (desirability approach) may be used. The process optimization may be performed by applying optimization algorithms (e.g., quadratic programming, particle swarm optimization) to the objective function defined by the desirability function approach.

On the other hand, in the process optimization problem, there is process uncertainty due to measurement errors of quality variables, setting errors of process parameters, errors caused by omission of uncontrollable factors during process optimization, or the like. In consideration of such uncertainty, there is a need for a technology for optimizing each parameter interval along with values of each parameter that may obtain desired quality variable values and providing a user with the optimized parameter intervals and values.

In order to solve the above problem, an embodiment of the present invention proposes a method of optimizing each process parameter interval so that all process parameter vectors included in an input space defined by the optimized parameter interval may have quality variable values that are statistically similar to the optimized parameter vector by considering the process uncertainty due to the measurement errors of the quality variables, the setting errors of the process parameters, the errors caused by the omission of the uncontrollable factors during the process optimization, or the like.

The embodiment of the present invention aims to optimize each parameter interval [x*_{LB,j}, x*_{UB,j}](ⱼ=1, . . . ,p) capable of enclosing an optimal solution x*=[x*₁, . . . , X*ₚ]^{T} which is obtained by applying an arbitrary optimization algorithm to an objective function, in a p-dimensional input space.

In addition, according to an embodiment of the present invention, each process parameter interval is optimized so that all process parameter vectors x included in the input space defined by the optimized parameter intervals may obtain the value of the quality variable that is statistically similar to the optimized parameter vector x*.

Such an embodiment of the present invention is not limited to the field of application of the manufacturing process, and the proposed methods can be applied to all industrial processes that may depict the relationship between the controllable factors and the quality variables as illustrated in FIG. 1.

Hereinafter, a method of optimizing parameter intervals of manufacturing processes based on prediction intervals according to an embodiment of the present invention will be described with reference to the accompanying drawings.

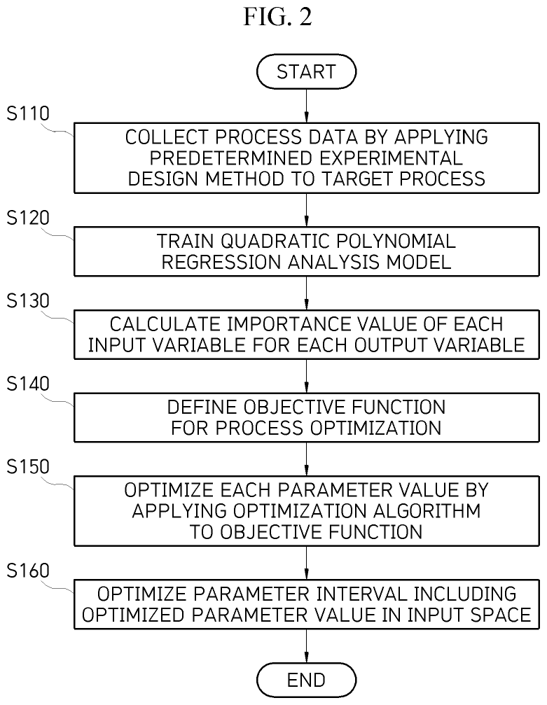

FIG. 2 is a flowchart of a method of optimizing parameter intervals of manufacturing processes based on prediction intervals according to an embodiment of the present invention.

Meanwhile, steps illustrated in FIG. 2 may be understood to be performed by a server (hereinafter, referred to as a server) constituting the system 100 for optimizing parameter intervals of manufacturing processes based on prediction intervals, but are not limited thereto.

According to an aspect of the present invention, the method for optimizing parameter intervals of manufacturing processes based on prediction intervals includes: collecting process data by applying an experiment design method to a target process (S110); training a second-order polynomial regression model based on the collected process data (S120); estimating importance values of each input variable with respect to each output variable using the second-order polynomial regression model (S130); defining an objective function for process optimization based on the second-order polynomial regression model (S140); optimizing each parameter value by applying an optimization algorithm to the defined objective function (S150); and optimizing each parameter interval including the optimized parameter value in an input space using the prediction interval of the second-order polynomial regression model (S160).

In the case of a general process of performing process optimization, the remaining steps except for steps S130 and S160 are sequentially performed to complete the process optimization. On the other hand, according to an embodiment of the present invention, a process of estimating importance values of each input variable and a process of optimizing each parameter interval are additionally performed.

In this case, step S150 corresponds to ‘point optimization’ for optimizing process parameter values, and step S160 corresponds to ‘interval optimization’ for optimizing process parameter intervals. In the process of optimizing the process parameter intervals, the importance value of the input variable to the output variable is required, which is estimated through step S130.

First, the server collects process data by applying an experimental design method to the target process (S110), and trains second-order polynomial regression models based on the collected process data (S120).

In this case, before training the second-order polynomial regression models, a step of standardizing values of all input variables of the second-order polynomial regression models to have a range between −1 and 1 may be further performed.

In one embodiment, the second-order polynomial regression model may be defined as a functional relationship between p input variables x₁, . . . , xₚ and a l-th quality variable yₗ(l=1, . . . , L)), and a second-order polynomial regression model may be described as in Equation 1 below.

$${y}_{l} = {f}_{l} ( x \vert {β}_{l} ) = {β}_{0}^{l} + {\sum }_{j = 1}^{p} {β}_{j}^{l} {x}_{j} + {\sum }_{j < k} {β}_{jk}^{l} {x}_{j} {x}_{k} + {\sum }_{j = 1}^{p} {β}_{jj}^{l} {x}_{j}^{2} + {ε}_{l} \qquad [ Equation 1 ]$$

In this case, in Equation 1, β₀^{l} corresponds to the intercept, βⱼ^{l}, βⱼₖ^{l}, and βⱼⱼ^{l} correspond to a linear coefficient, an interaction coefficient, and a quadratic coefficient corresponding to the input variables, respectively, and εₗ corresponds to an error term.

In Equation 1, a total number of regression coefficients to be estimated based on the experimental data set {(xᵢ∈ [symbol] ^{p}; yᵢ∈ [symbol] ^{L})}nᵢ₌₁ⁿ composed of n samples is p′=1+2p+p(p−1)/2.

An output vector yₗ=[y₁ₗ . . . , yₙₗ]^{T}∈ [symbol] ⁿ may be composed of collected n measured values of the l-th quality variable. Also, a design matrix is set as Z[=zₗ . . . , zₙ]^{T}∈ [symbol] ^{n×p′}, and an i-th row of the matrix Z is zᵢ^{T}=z(xᵢ)^{T}=[1, xᵢₗ, . . . xᵢₚ, Xᵢ₁Xᵢ₂, . . . Xᵢ₍ₚ₋₁₎Xᵢₚ, . . . , Xᵢₚ², . . . , xᵢₚ²]. Based on the vector y₁ and the matrix Z, a least squares estimation value of a coefficient vector β^{l}∈ [symbol] ^{p′}composed of p′ coefficients can be expressed as \hat{β}^{l}=(Z^{T}Z)⁻¹Z^{T}yₗ (l=1, . . . , L).

Here,

$${s}_{l} = \sqrt{\frac{1}{n - {p}^{′}} {\sum }_{i = 1}^{n} {( {y}_{il} - {\hat{y}}_{il} )}^{2}}$$

may be used as an unbiased estimate of a standard deviation σ_{ε}_{ₗ} of the error term εₗ, where

$${y}_{l} = {f}_{l} ( x \vert {β}_{l} ) = {β}_{0}^{l} + {\sum }_{j = 1}^{p} {β}_{j}^{l} {x}_{j} + {\sum }_{j < k}^{} {β}_{jk}^{l} {x}_{j} {x}_{k} + {\sum }_{j = 1}^{p} {β}_{jj}^{l} {x}_{j}^{2} + {ε}_{l} \qquad [ Equation 1 ]$$

Next, the output value of the second-order polynomial regression model of Equation 1 of an arbitrary input vector a x_{new}=[x_{new,l}, . . . x_{new,p}]^{T} can be expressed as \hat{γ}ₗ(x_{new})=z(x_{new})^{T}\hat{β}^{l}=z_{new}^{T}\hat{β}^{l}, and a 100×(1−α)% prediction interval [PI_{LB}^{l}(x_{new}), PI_{UB}^{l}(x_{new})] of the output value prediction intervals (prediction interval) is calculated by Equation 2 below.

PI_{LB}^{l}(x_{new})=ŷₗ(x_{new})−t_{1-α/2}(n−p′)sₗ\sqrt{1+z_{new}^{T}(Z^{T}Z)⁻¹z_{new}}

PI_{UB}^{l}(x_{new})=ŷₗ(x_{new})−t_{1-α/2}(n−p′)sₗ\sqrt{1+z_{new}^{T}(Z^{T}Z)⁻¹z_{new}} [Equation 2]

In this case, in Equation 2, a denotes a significance level of the prediction interval, and t_{1-α/2}(n−p′) denotes a (1−α/2)-th percentile of a t distribution having a degree of freedom of n−p′.

Next, a server calculates importance values of each input variable with respect to each output variable using the trained second-order polynomial regression model (S130).

In step S130, the server estimates the importance values for each output variable yₗ(l=1, . . . ,L) of each input variable xⱼ(j=1, . . . , p) using the trained regression model ŷₗ(x)=fₗ(x|\hat{β}^{l}). In step S130, the server may use various methods to calculate the importance value, which is not limited to any specific method.

After step S130 ends, an importance matrix Iᵢₘₚ ∈ [symbol] ^{L×p} is calculated, and a j-th column of an l-th row of an importance matrix Iᵢₘₚ denotes the importance value of the l-th output variable of the j-th input variable. In this case, as the input variable xᵢ has a greater influence on the quality variable yₗ, the importance value increases, and the range of the importance value should all be the same (e.g., Iᵢₘₚ (l,j)∈[0,1]).

Next, the server defines an objective function for process optimization based on the second-order polynomial regression model (S140).

In step S140, an objective function for solving multiple response optimization (MRO) problems with multiple quality variables is defined using the desirability function approach based on regression equations ŷₗ(x) completed in step S120.

In this process, different desirability functions are used depending on whether to maximize or minimize the quality variable, and whether a target value is present in the quality variable. The desirability function serves to transform the output value ŷₗ(x) of the second-order polynomial regression model into a value between 0 and 1.

In one embodiment, the desirability function may include any one of a desirability function for maximizing the quality variable, a desirability function for minimizing the quality variable, and a desirability function for when the target value is set for the quality variable.

For example, a desirability function dₗ(.) for the quality variable yₗ for which the target value is set is defined as in Equation 3 below.

$${d}_{l} ( {\hat{y}}_{l} ( x ) ) = \{ \begin{matrix}0 & if {\hat{y}}_{l} ( x ) < {y}_{l , min} \\ {( \frac{{\hat{y}}_{l} ( x ) - {y}_{l , min}}{{y}_{l , target} - {y}_{l , min}} )}^{s} & if {y}_{l , min} \leq {\hat{y}}_{l} ( x ) \leq {y}_{l , target} \\ {( \frac{{\hat{y}}_{l} ( x ) - {y}_{l , max}}{{y}_{l , target} - {y}_{l , max}} )}^{t} & if {y}_{l , target} \leq {\hat{y}}_{l} ( x ) \leq {y}_{l , max} \\ 0 & if {\hat{y}}_{l} ( x ) > {y}_{l , max}\end{matrix} \qquad [ Equation 3 ]$$

In Equation 3, ŷₗ(x) is the regression expression of yₗ, y_{l,min} and y_{l,max} are lower and upper bound values of yₗ, respectively. The upper and lower bound values may be calculated from observed values y₁ₗ, . . . , yₙₗ of the collected quality variables. y_{l,target}∈[y_{l,min}, y_{l,max}] is a target value set for yₗ, and s and t are design values that determine a shape of the desirability function.

In Equation 3, when the function value ŷₗ(x) is greater than the upper bound or less than the lower bound, the value of the desirability function is 0. As ŷₗ(x) approaches the target value, the value of dₗ(.) approaches 1.

Also, to minimize the quality variable y₁, the desirability function of Equation 4 below is used.

$${d}_{l} ( {\hat{y}}_{l} ( x ) ) = \{ \begin{matrix}1 & if {\hat{y}}_{l} ( x ) < {y}_{l , min} \\ {( \frac{{y}_{l , max} - {\hat{y}}_{l} ( x )}{{y}_{l , max} - {y}_{l , min}} )}^{t} & if {y}_{l , min} \leq {\hat{y}}_{l} ( x ) \leq {y}_{l , max} \\ 0 & if {\hat{y}}_{l} ( x ) > {y}_{l , max}\end{matrix} \qquad [ Equation 4 ]$$

In Equation 4, as the output value ŷ₁(x) approaches the lower bound, the value of dₗ(.) approaches 1, and as the output value approaches the upper bound, the value of dₗ(.) approaches 0.

In addition, the desirability function used when the goal is to maximize the quality variable is the same as Equation 5.

$${d}_{l} ( {\hat{y}}_{l} ( x ) ) = \{ \begin{matrix}0 & if {\hat{y}}_{l} ( x ) < {y}_{l , min} \\ {( \frac{{\hat{y}}_{l} ( x ) - {y}_{l , min}}{{y}_{l , max} - {y}_{l , min}} )}^{t} & if {y}_{l , min} \leq {\hat{y}}_{l} ( x ) \leq {y}_{l , max} \\ 1 & if {\hat{y}}_{l} ( x ) > {y}_{l , max}\end{matrix} \qquad [ Equation 5 ]$$

In Equation 5, as the output value ŷ₁(x) approaches the upper bound, the desirability function value approaches 1, and as the output value approaches the lower bound, the desirability function value approaches 0.

After the desirability function is defined as described above, the overall desirability function D(x) expressed by Equation 6 applying the weighted geometric mean of the desirability function dₗ(.) (l=1, . . . ,L) defined as in Equations 3 to 5 is used as the objective function of the MRO problem.

$$D ( x ) = {( {\prod }_{l = 1}^{L} {{d}_{l} ( {\hat{y}}_{l} ( x ) )}^{{w}_{l}} )}^{1 / {\sum }_{t} {w}_{l}} \qquad [ Equation 6 ]$$

In Equation 6, wₗ is a weight assigned to the l-th quality variable. As all desirability function values approach 1, the value of D(x) also approaches 1.

Next, the server optimizes each parameter value by applying an optimization algorithm to the defined objective function (S150).

That is, the server finds the optimal solution (vector composed of optimal input parameters) x* by applying the optimization algorithm to the objective function defined as in Equation 6.

$${x}^{*} = {argmax}_{x ∈ {[ - 1 , 1 ]}^{p}} D ( x ) \qquad [ Equation 7 ]$$

In order to find the optimal solution x*, the server may use both an optimization method (e.g., numerical optimization methods) based on differentiation and an optimization method (e.g., metaheuristics) not based on differentiation.

Next, the server optimizes each parameter interval including the optimized parameter values in the input space using the prediction intervals of the second-order polynomial regression model (S160), and provides (or recommends) the optimized interval of the parameter to a user (process operator or engineer).

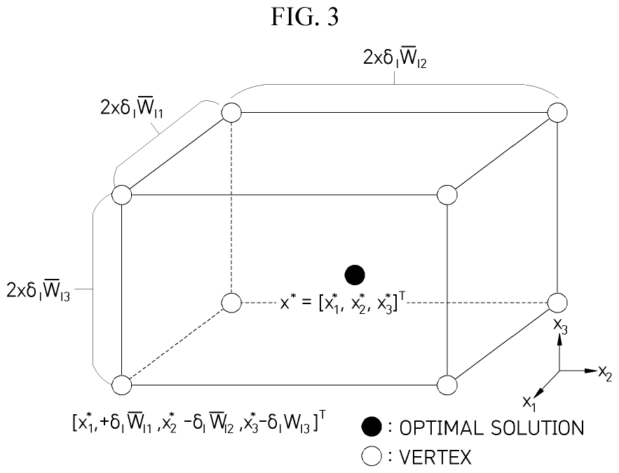

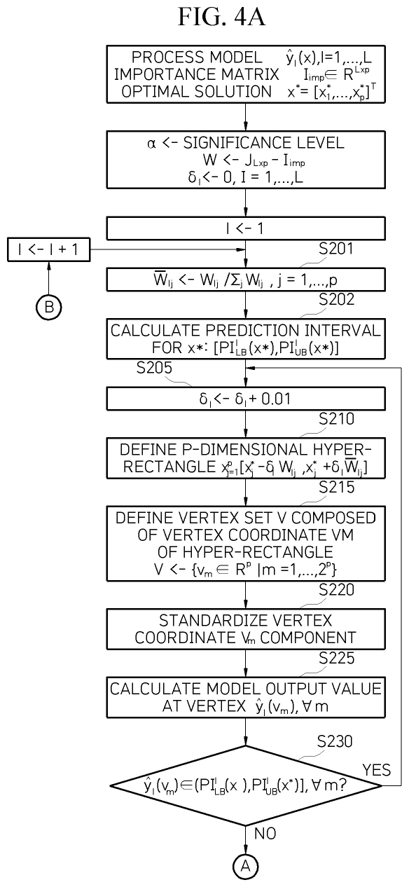

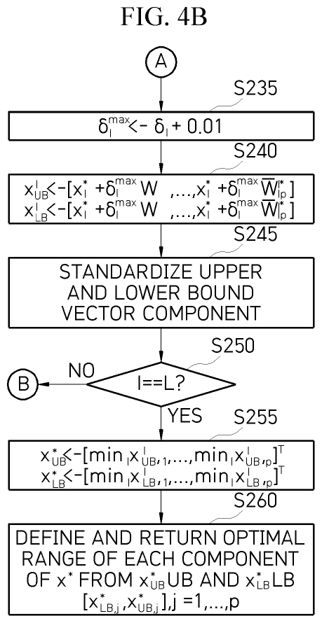

FIG. 3 is a diagram illustrating an example of a defined hyper-rectangle in an embodiment of the present invention. FIG. 4A AND FIG. 4B are diagram for describing a process of optimizing process parameter intervals.

In step S160, the server optimizes each parameter interval [X*_{LB,j}, X*_{UB,j}] (j=1, . . . ,p) which may enclose the parameter vector value x*=[x*₁, . . . , x*ₚ]^{T} optimized in step S150 in the input space, in consideration of the process uncertainty. That is, in an embodiment of the present invention, the optimized parameter intervals satisfy the following: x*ⱼ∈[x*_{LB,j}, x*_{UB,j}], ∀j.

In this case, it is desirable that all input vectors included in the optimized parameter intervals obtain similar quality variable values to the optimized parameter vector x* from a statistical point of view.

Meanwhile, an embodiment of the present invention defines a hyper-rectangle that has the parameter value x* optimized in the p-dimensional input space as a center and has 2p vertices vₘ∈ [symbol] ^{p}(m=1, . . . ,2^{p}) as illustrated in FIG. 3. In this case, FIG. 3 illustrates an example of a hyper-rectangle having 8 (=2³) vertices defined in a three-dimensional input space.

The server may find the hyper-rectangle defined immediately before the output values ŷₗ(vₘ) (l=1, . . . ,L) of all the vertices deviate from the prediction intervals [P_{LB}^{l}(x*),PI_{UB}^{l}(x*)] (l=1, . . . , L) of the optimized parameter value x* corresponding thereto while increasing the length of the corner of the hyper-rectangle. The server may easily define the optimized intervals of each parameter based on the hyper-rectangles.

Meanwhile, the server may calculate weight values W̅ₗⱼ(j=1, . . . ,p,l=1, . . . ,L) from the importance matrix Iᵢₘₚ obtained in step S130 (S201). The calculated weight values are used to differentially increase the length of the corner of the hyper-rectangles.

That is, the higher the importance value, the shorter the corresponding length of the corner.

Then, the server calculates the prediction interval [P_{LB}^{l}(x*),PI_{UB}^{l}(x*)] (l=1, . . . , L) of the optimized parameter value x calculated in step S150 (S202), and uses the calculated prediction interval to optimize the process parameter interval.

The process of optimizing process parameter intervals will be described in more detail as follows with reference to FIG. 4A AND FIG. 4B.

First, the server defines a hyper-rectangle having a length of a corner of 2×δₗW̅ₗⱼ parallel to a j-th input axis in the p-dimensional input space (S210). Here, δₗ denotes a positive increment used to gradually increase the length of the corner (S205). The server may define the hyper-rectangle as a Cartesian product of p intervals as follows: xⱼ₌₁^{p}[x*ⱼ−δₗW̅ₗⱼ,x*ⱼ+δₗW̅ₗⱼ]. Here, x is a Cartesian product operator.

Next, the server defines a vertex set for the vertex coordinates of the hyper-rectangle (S215). That is, the server configures a vertex set V={vₘ∈ [symbol] ^{p}|m=1, . . . , 2^{p}} having 2p vertices vₘ∈ [symbol] ^{p} of the hyper-rectangle.

In this case, the server replaces a component greater than +1 with +1 among components of the vertex coordinate vₘ and replaces a component smaller than −1 with −1 while increasing the length of the corner of the hyper-rectangle (S220). This is because each component of the input vector x of the process model is always included in the range [−1, 1] by standardization. That is, xⱼ∈[−1,1], ∀j.

Next, the server calculates the output values ŷₗ(vₘ) at all vertices of the hyper-rectangle (S225, S230), and the maximum value δₗ^{max}(l=1, . . . ,L) of the positive increment δₗ that causes the output value to be included in the corresponding prediction interval [PI_{LB}^{l}(x*), PI_{UB}^{l}(x*)] is detected through a grid search (S235).

After detecting the positive increment that causes the output values at all vertices to be included in the prediction intervals, the server defines, for all l=1, . . . ,L corresponding to the output variables (S250), the upper and lower bound vectors x_{UB}^{l} and x_{LB}^{l} as in the following Equation 8 (S240).

x_{UB}^{l}=[x*ₗ+δₗ^{max}W̅ₗ₁, . . . ,x*ₚ+6ₗ^{max}W̅ₗₚ]^{T}and x_{LB}^{l}=[x*ₗ−δₗ^{max}W̅ₗ₁, . . . ,x*ₚ−δₗ^{max}W̅ₗₚ]^{T} [Equation 8]

The server replaces the vector component greater than +1 with +1 and replaces the component smaller than −1 with −1 in Equation 8 (S245).

Next, the server defines L different hyper-rectangles as follows based on the upper and lower bound vectors x_{UB}^{l} and x_{LB}^{l}: xⱼ₌₁^{p}[x_{LB,j}^{l},x_{UB,j}^{l}] (l=1, . . . ,L). In this case, the L different hyper-rectangles may have different regions occupied in the input space.

Finally, the server acquires the upper and lower bound vectors x*_{UB} and x*_{LB} as in Equation 9, for the overlapping areas of L defined hyper-rectangles (S255).

x*_{UB}=[minₗx_{UB,1}^{l}, . . . ,minₗx_{UB,p}^{l}]^{T} and x*_{LB}=[maxₗx_{LB,1}^{l}, . . . ,maxₗx_{LB},p^{l}]^{T} [Equation 9]

In Equation 9, the upper and lower bound vectors x*_{UB} and x*_{LB} are respectively composed of the upper and lower bounds of the optimized parameter intervals for the optimized parameter x*, and the server may easily define the optimized intervals [x*_{LB,j},x*_{UB,j}] (j=1, . . . ,p) of each parameter based on the upper and lower bound vectors x*_{UB} and x*_{LB} (S260). In this case, all input vectors x included in the space defined by the optimized parameter intervals satisfy the following conditions: ŷₗ(x)∈(PI_{LB}^{l}(x*),PI_{UB}^{l}(x*)),∀l. This means that all input vectors included in the input area may obtain quality variable values similar to x*.

After the parameter intervals are calculated in this way, the server recommends or provides the parameter intervals to a user (process operator or engineer).

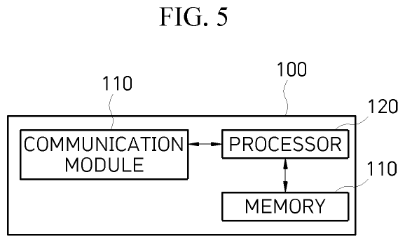

Meanwhile, in the above description, steps S110 to S260 may be further divided into additional operations or combined into fewer operations according to an embodiment of the present invention. Also, some steps may be omitted if necessary, and an order between the operations may be changed. In addition, the contents of the method of optimizing parameter intervals of manufacturing processes based on prediction intervals of FIGS. 1 to 4 may also be applied to the contents of FIG. 5, which will be described later, even if other contents are omitted.

Hereinafter, the system 100 for optimizing parameter intervals of manufacturing processes based on prediction intervals according to an embodiment of the present invention will be described.

FIG. 5 is a diagram for describing the system 100 for optimizing parameter intervals of manufacturing processes based on prediction intervals according to the embodiment of the present invention.

Referring to FIG. 5, the system 100 for optimizing parameter intervals of manufacturing processes based on prediction intervals according to an embodiment of the present invention includes a communication module 110, a memory 120, and a processor 130.

The communication module 110 receives process data collected by applying an experimental design method to the target process.

The memory 120 stores a program for performing parameter interval optimization based on the process data and providing optimized parameter intervals to a user, and the processor 130 executes the program stored in the memory 120.

The processor 130 trains second-order polynomial regression models based on the collected process data, and estimates importance values of each input variable for each output variable using the trained second-order polynomial regression models. Then, the processor 130 defines objective functions for process optimization based on the trained second-order polynomial regression models, applies optimization algorithms to the defined objective functions to optimize each parameter values, and then optimizes parameter intervals including the optimized parameter values in the input space using the prediction intervals of the second-order polynomial regression model.

The system 100 for optimizing parameter intervals of manufacturing processes based on prediction intervals described with reference to FIG. 5 may be provided as a component of the above-described server.

The method of optimizing parameter intervals of manufacturing processes based on prediction intervals according to the embodiment of the present invention described above may be implemented as a program (or application) and stored in a medium to be executed in combination with a computer that is hardware.

In order for the computer to read the program and execute the methods implemented as the program, the program may include a code coded in a computer language such as fortran, python, R, MATLAB, C, C++, JAVA, Ruby, or machine language that the processor (CPU) of the computer may read through a device interface of the computer. Such code may include functional code related to a function or such defining functions necessary for executing the methods and include an execution procedure related control code necessary for the processor of the computer to execute the functions according to a predetermined procedure. In addition, the code may further include a memory reference related code for which location (address street number) in an internal or external memory of the computer the additional information or media necessary for the processor of the computer to execute the functions is to be referenced at. In addition, when the processor of the computer needs to communicate with any other computers, servers, or the like located remotely in order to execute the above functions, the code may further include a communication-related code for how to communicate with any other computers, servers, or the like using the communication module of the computer, what information or media to transmit/receive during communication, and the like.

The storage medium is not a medium that stores images therein for a while, such as a register, a cache, a memory, or the like, but means a medium that semi-permanently stores the images therein and is readable by an apparatus. Specifically, examples of the storage medium include, but are not limited to, ROM, random-access memory (RAM), CD-ROM, a magnetic tape, a floppy disk, an optical image storage device, and the like. That is, the program may be stored in various recording media on various servers accessible by the computer or in various recording media on the computer of the user. In addition, media may be distributed in a computer system connected by a network, and a computer-readable code may be stored in a distributed manner.

According to the present invention described above, when a user sets process parameter values based on an optimal parameter vector, it is possible to easily check allowable setting errors of each parameter value. That is, the allowable setting error of the parameter value increases in proportion to a length of the optimized interval, and the optimized interval enables a user to check whether a certain process parameter needs to be set more precisely in order to obtain a desired quality variable value and whether another specific process parameter needs to be set relatively less precisely. In addition, according to an embodiment of the present invention, it is possible to usefully use a recommended optimal interval when fine-tuning a parameter value by reflecting user's experiential knowledge or considering a field situation. That is, all parameter vectors x included in an area defined by the optimized interval can obtain quality variable value statistically similar to the optimized parameter vector x*, so a user can flexibly adjust parameter values within this area.

The effects of the present invention are not limited to the above-described effects, and other effects that are not mentioned may be obviously understood by those skilled in the art from the following description.

The above description of the present invention is for illustrative purposes, and those skilled in the art to which the present invention pertains will understand that it may be easily modified to other specific forms without changing the technical spirit or essential features of the present invention. Therefore, it is to be understood that the embodiments described hereinabove are illustrative rather than being restrictive in all aspects. For example, each component described as a single type may be implemented in a distributed manner, and similarly, components described as distributed may be implemented in a combined form.

It is to be understood that the scope of the present invention will be defined by the claims rather than the above-described description and all modifications and alternations derived from the claims and their equivalents are included in the scope of the present invention.

What is claimed is:

1. A method of optimizing, by a computer, parameter intervals of manufacturing processes based on prediction intervals, the method comprising:
collecting process data by applying an experiment design method to a target process;
training a second-order polynomial regression model based on the collected process data;
estimating importance values of each input variable with respect to each output variable using the second-order polynomial regression model;
defining an objective function for process optimization based on the second-order polynomial regression model;
optimizing each parameter value by applying an optimization algorithm to the defined objective function; and
optimizing each parameter interval including the optimized parameter value in an input space using the prediction interval of the second-order polynomial regression model.

2. The method of claim 1, further comprising:
standardizing a range of values of all input variables of the second-order polynomial regression model to have a value between −1 and 1.

3. The method of claim 1, wherein the second-order polynomial regression model is determined by a functional relationship between p input variables and a l-th quality variable.

4. The method of claim 3, wherein the second-order polynomial regression model is a functional relationship between p input variables (x₁, . . . , xₚ) and the l-th quality variable (yₗ, l=1, . . . , L), and is determined by the following Equation, where β₀^{l} is an intercept, βⱼ^{l}, βⱼₖ^{l}, and βⱼⱼ^{l} are a linear coefficient, an interaction coefficient, and a quadratic coefficient corresponding to input variables, respectively, and εₗ is an error term.
$${y}_{l} = {f}_{l} ( x \vert {β}_{l} ) = {β}_{0}^{l} + {\sum }_{j = 1}^{p} {β}_{j}^{l} {x}_{j} + {\sum }_{j < k}^{} {β}_{jk}^{l} {x}_{j} {x}_{k} + {\sum }_{j = 1}^{p} {β}_{jj}^{l} {x}_{j}^{2} + {ε}_{l} \qquad [ Equation ]$$

5. The method of claim 3, wherein the training of the second-order polynomial regression model based on the collected process data includes estimating a total of p′ regression coefficients based on the process data having the p input variables, and the p′ is determined by the following Equation.
p′=1+2p+p(p−1)/2[Equation]

6. The method of claim 5, wherein the training of the second-order polynomial regression model based on the collected process data includes:
calculating a least squares estimate of a coefficient vector composed of the p′ regression coefficients based on an output vector composed of collected n measured values of the l-th quality variable and a design matrix;
calculating an output value of a second-order polynomial regression model corresponding to an arbitrary input vector; and
calculating a prediction interval of the calculated output value.

7. The method of claim 3, wherein the defining of the objective function for process optimization based on the trained second-order polynomial regression model includes:
defining a desirability function for converting the output value of the second-order polynomial regression model into a value between 0 and 1; and
defining, as the objective function, an overall desirability function to which a weighted geometric mean of the defined desirability function is applied.

8. The method of claim 7, wherein the desirability function includes any one of a desirability function for maximizing the quality variable, a desirability function for minimizing the quality variable, and a desirability function for when a target value is set for the quality variable.

9. The method of claim 8, wherein the optimizing of each parameter interval including the optimized parameter value in the input space using the prediction interval of the second-order polynomial regression model includes:
defining a hyper-rectangle centered on the optimized parameter value in a P (P is a natural number)-dimensional input space;
defining a vertex set for vertex coordinates of the hyper-rectangle;
detecting a maximum positive increment so that output values at all the vertices of the hyper-rectangle are included in a prediction interval corresponding to a prediction value;
defining upper and lower bound vectors to correspond to the number of output variables, respectively;
defining different hyper-rectangles based on the defined upper and lower bound vectors;
obtaining upper and lower bound vectors for an overlapping area of the defined different hyper-rectangles; and
calculating optimized intervals of each parameter based on the upper and lower bound vectors for the overlapping area.

10. The method of claim 8, further comprising:
replacing a component greater than 1 with 1 and replacing a component smaller than −1 with −1 among component values of the vertex coordinates while increasing a length of a corner of the hyper-rectangle.

11. A system for optimizing parameter intervals of manufacturing processes based on prediction intervals, the system comprising:
a communication module that receives process data collected by applying an experimental design method to a target process;
a memory in which a program for optimizing the parameter intervals based on the process data is stored; and
a processor that executes the program stored in the memory,
wherein the processor trains a second-order polynomial regression model based on the collected process data by executing the program, estimates importance values of each input variable for each output variable using the trained second-order polynomial regression model, define an objective function for process optimization based on the trained second-order polynomial regression model, and optimizes each parameter value by applying an optimization algorithm to the defined objective function and then optimizes each parameter interval including the optimized parameter value in an input space using the prediction interval of the second-order polynomial regression model.

12. The system of claim 11, wherein the processor standardizes a range of values of all input variables of the second-order polynomial regression model to have a value between −1 and 1.

13. The system of claim 11, wherein the second-order polynomial regression model is a functional relationship between p input variables and a l-th quality variable.

14. The system of claim 13, wherein the second-order polynomial regression model is a functional relationship between p input variables (x₁, . . . , xₚ) and the l-th quality variable (yₗ, 1=1, . . . ,L), and is determined as the following Equation, where β₀^{l} is an intercept, βⱼ^{l}, βⱼₖ^{l}, and βⱼⱼ^{l} are a linear coefficient, an interaction coefficient, and a quadratic coefficient corresponding to input variables, respectively, and εₗ is an error term.
$${y}_{l} = {f}_{l} ( x \vert {β}_{l} ) = {β}_{0}^{l} + {\sum }_{j = 1}^{p} {β}_{j}^{l} {x}_{j} + {\sum }_{j < k}^{} {β}_{jk}^{l} {x}_{j} {x}_{k} + {\sum }_{j = 1}^{p} {β}_{jj}^{l} {x}_{j}^{2} + {ε}_{l} \qquad [ Equation ]$$

15. The system of claim 13, wherein the processor estimates a total of p′ regression coefficients based on the process data having the p input variables, where the p′ is determined by the following Equation.
p′=1+2p+p(p−1)/2[Equation]

16. The system of claim 15, wherein the processor calculates a least squares estimate of a coefficient vector composed of the p′ regression coefficients based on an output vector composed of collected n measured values of the l-th quality variable and a design matrix, calculates an output value of the second-order polynomial regression model corresponding to an arbitrary input vector, and calculates a prediction interval of the calculated output value.

17. The system of claim 13, wherein the processor defines a desirability function for converting the output value of the second-order polynomial regression model into a value between 0 and 1, and defines the overall desirability function to which a weighted geometric mean of the defined desirability function is applied as the objective function.

18. The system of claim 17, wherein the desirability function includes any one of a desirability function for maximizing the quality variable, a desirability function for minimizing the quality variable, and a desirability function for when a target value is set for the quality variable.

19. The system of claim 18, wherein the processor defines a hyper-rectangle centered on the optimized parameter value in a p (p is a natural number)-dimensional input space, defines a vertex set for vertex coordinates of the hyper-rectangle, detects a maximum positive increment so that output values at all the vertices of the hyper-rectangle are included in a prediction interval corresponding to a prediction value, defines upper and lower bound vectors to correspond to the number of output variables, respectively, defines different hyper-rectangles based on the defined upper and lower bound vectors, obtains upper and lower bound vectors for an overlapping area of the defined different hyper-rectangles, and calculates optimized intervals of each parameter based on the upper and lower bound vectors for the overlapping area.

20. The system of claim 18, wherein the processor replaces a component greater than 1 with 1 and replaces a component smaller than −1 with −1 among component values of the vertex coordinates while increasing a length of a corner of the hyper-rectangle.
